(19) United States
(12) Patent Application Publication
(10) Pub. No.: US 2005/0156411 A1
(43) Pub. Date: Jul. 21, 2005

(54) Method and apparatus for helping to protect an occupant of a vehicle

(75) Inventors: Charles E. Steffens JR., Washington, MI (US); Navin Chopra, Rohester Hills, MI (US)

Correspondence Address: TAROLLI, SUNDHEIM, COVELL, & TUMMINO L.L.P., 1111 LEADER BLDG., 526 SUPERIOR AVENUE, CLEVELAND, OH, 44114-1400, US

(73) Assignee: TRW Vehicle Safety Systems Inc.

(21) Appl. No.: 10/760,439

(22) Filed: Jan. 20, 2004

(51) Int. Cl. B60R 21/24

(52) U.S. Cl. 280/729; 280/735

(57) ABSTRACT

A method and apparatus (12, 112) for helping to protect an occupant (30, 130) of a seat (14, 114) of a vehicle (10, 110) includes a sensor (36, 200) responsive to at least one of a side impact event or a rollover event for providing a crash event signal. A first vehicle occupant protection device (94, 210) is inflatable into a first position located beside the seat (14, 114). A second vehicle occupant protection device (50, 150) is inflatable into a second position located forward of the seat (14, 114). A controller (44, 144) is responsive to the crash event signal for immediately inflating the first vehicle occupant protection device (94, 210) and, a predetermined time after inflating the first vehicle occupant protection device (94, 210), inflating the second vehicle occupant protection device (50, 150).

### TECHNICAL FIELD

The present invention relates to a method and apparatus for helping to protect an occupant of a vehicle. More particularly, the present invention relates to a method and an apparatus that includes two inflatable vehicle occupant protection devices that are inflatable for helping to protect an occupant of a vehicle.

### BACKGROUND OF THE INVENTION

Current vehicle occupant safety apparatuses are designed for helping to protect a vehicle occupant during a single impact crash event. Some examples of single impact crash events include a front only crash event, a side only crash event, and a rollover only crash event. It is common for vehicle occupant safety. apparatuses to inflate only a single air bag in response to the occurrence of the crash event. The particular air bag that is inflated is dependent upon the type of crash event that is detected. For example, when a side only crash event is detected, the side air bag associated with the impacted side of the vehicle is inflated for helping to protect the occupant of the vehicle.

A multiple impact crash event is a crash event in which an individual vehicle experiences more than one impact during the occurrence of the crash event. Statistics show that multiple impact crash events are common. The article titled “Multiple Impact Crashes—Consequences For Occupant Protection Measures,” by Paul A. Fay et al. concludes that nearly thirty percent of all vehicle accidents include multiple impact crash events. Current vehicle occupant protection devices regard multiple impact crash events as separate single impact crash events.

### SUMMARY OF THE INVENTION

The present invention relates to an apparatus for helping to protect an occupant of a seat of a vehicle. The apparatus comprises a sensor responsive to at least one of a side impact event or a rollover event for providing a crash event signal. A first vehicle occupant protection device is inflatable into a first position located beside the seat. A second vehicle occupant protection device is inflatable into a second position located forward of the seat. A controller is responsive to the crash event signal for immediately inflating the first vehicle occupant protection device and, a predetermined time after inflation of the first vehicle occupant protection device, inflating the second vehicle occupant protection device.

According to another aspect, the present invention relates to an apparatus for helping to protect an occupant of a seat of a vehicle. The apparatus comprises a sensor responsive to at least one of a side impact event or a rollover event for providing a crash event signal. A first vehicle occupant protection device is inflatable into a first position located beside the seat. A second vehicle occupant protection device is inflatable into a second position located forward of the seat. A controller is responsive to the crash event signal from the sensor for inflating both the first and second vehicle occupant protection devices.

According to yet another aspect, the present invention relates to an apparatus for helping to protect an occupant of a seat of a vehicle. The apparatus comprises a sensor responsive to a vehicle crash event for providing a crash event signal. A first vehicle occupant protection device is mounted to the vehicle in a position forward of the seat and is inflatable into a first position located forward of the seat. A controller is responsive to the crash event signal for inflating the first vehicle occupant protection device. The first vehicle occupant protection device is configured to remain in a mostly inflated condition in the first position for at least about 300 milliseconds.

The present invention also relates to a method for helping to protect an occupant of a seat of a vehicle. The method comprises the steps of: sensing at least one of a side impact event or a rollover event and providing a crash event signal; immediately inflating a first vehicle occupant protection device into a first position located beside the seat; and inflating, a predetermined time after inflating the first vehicle occupant protection device, a second vehicle occupant protection device into a second position located forward of the seat.

According to another aspect, the present invention relates to a method for helping to protect an occupant of a seat of a vehicle. The method comprises the steps of: sensing at least one of a side impact event or a rollover event for providing a crash event signal; inflating a first vehicle occupant protection device into a first position located beside the seat; and inflating a second vehicle occupant protection device into a second position located forward of the seat.

In accordance with yet another aspect, the present invention relates to a method for helping to protect an occupant of a seat of a vehicle. The method comprises the steps of: sensing a vehicle crash condition and providing a crash event signal; inflating a first vehicle occupant protection device into a first position located forward of the seat; and sustaining the first vehicle occupant protection device in a mostly inflated condition in the first position for at least about 300 milliseconds.

### BRIEF DESCRIPTION OF THE DRAWINGS

The foregoing and other features of the present invention will become apparent to those skilled in the art to which the present invention relates upon reading the following description with reference to the accompanying drawings, in which:

FIG. 1 is a schematic side view of a vehicle including an apparatus constructed in accordance with the present invention;

FIG. 2 is a schematic block diagram of the apparatus of FIG. 1;

FIG. 3 is a cross-sectional view of an exemplary two-stage inflator that may form part of the apparatus of FIG. 1;

FIG. 4 is a flow diagram illustrating a process performed by the apparatus of the present invention;

FIG. 5 is a schematic side view of a vehicle including an apparatus constructed in accordance with a second embodiment of present invention;

FIG. 6 is a schematic block diagram of the apparatus of FIG. 5; and

FIG. 7 is a flow diagram illustrating a process performed by the apparatus constructed in accordance with a second embodiment of the present invention.

### DETAILED DESCRIPTION OF THE INVENTION

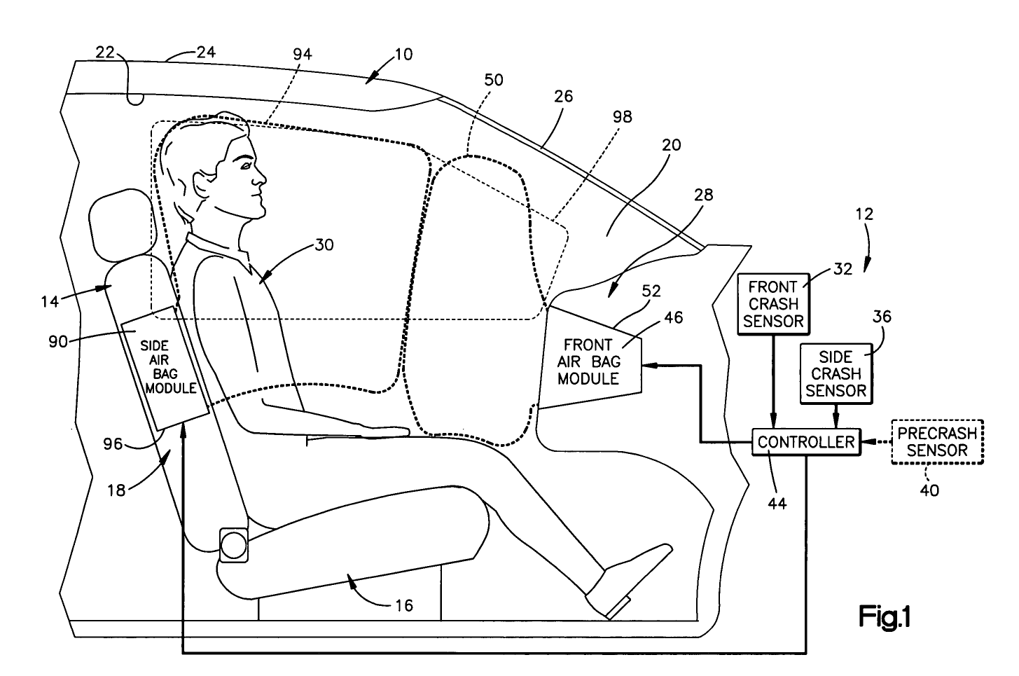

FIG. 1 is a schematic side view of a vehicle 10 including an apparatus 12 constructed in accordance with the present invention. For exemplary purposes, the apparatus 12 illustrated in FIG. 1 is associated with a front passenger seat 14 of the vehicle 10. The apparatus 12 may be associated with other seats (not shown) in the vehicle 10.

The passenger seat 14 of the vehicle 10 includes a cushion portion 16 and a backrest portion 18. The passenger seat 14 is located within a passenger compartment 20 of the vehicle 10. A headliner 22, which is attached to the roof 24 of the vehicle 10, and a windshield 26 collectively define an upper boundary of the passenger compartment 20. An instrument panel 28 is located in the passenger compartment 20 forward of and spaced away from the passenger seat 14.

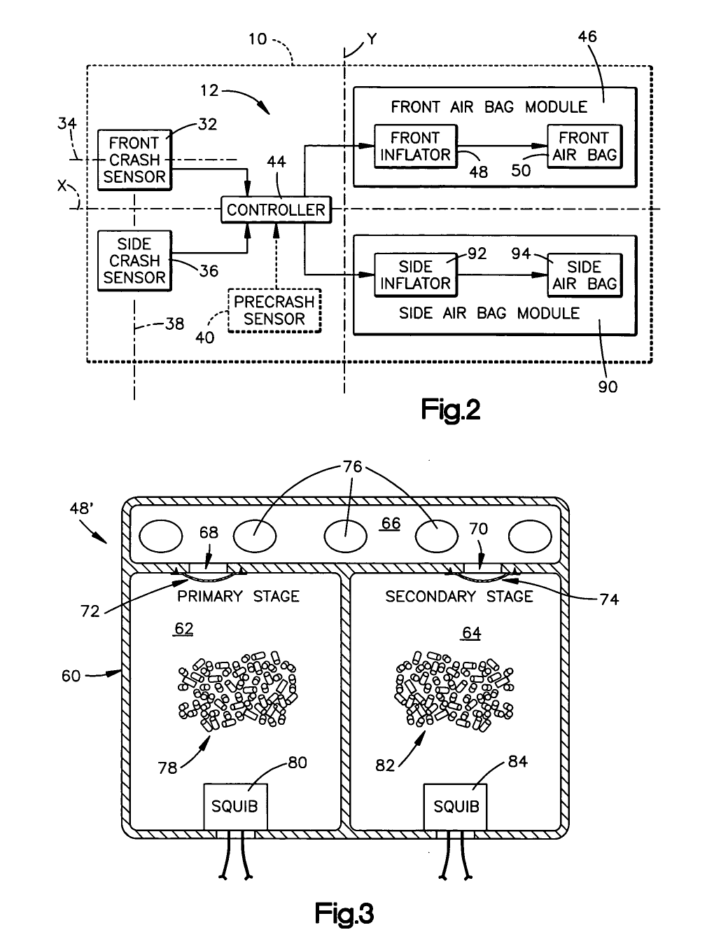

The apparatus 12 is configured for helping to protect an occupant 30 of the vehicle 10 during the occurrence of a single impact or a multiple impact crash event. The apparatus 12 includes a front crash sensor 32 for sensing a front impact event of the vehicle 10 and for providing a front crash signal in response to the sensed front impact event. The front crash sensor 32 may include an accelerometer having an axis of sensitivity 34 that extends parallel to a longitudinal axis X of the vehicle 10, as is shown schematically in FIG. 2. Additionally, the front crash sensor 32 may also include a crush sensor for sensing deformation or crush of a front portion of the vehicle 10. These types of sensors are well known in the art.

A side crash sensor 36 of the apparatus 12 senses a side impact event of the vehicle 10 and provides a side crash signal in response to the sensed side impact event. The side crash sensor 36 may include an accelerometer having an axis of sensitivity 38 that extends perpendicular to a longitudinal axis X of the vehicle 10 and parallel to a lateral axis Y of the vehicle, as is shown schematically in FIG. 2. Additionally, the side crash sensor 36 may also include at least one crush sensor for sensing deformation or crush of a side portion of the vehicle 10 and may includes multiple sensors spaced along the side portion of the vehicle. Again, these types of sensors are well known in the art.

The apparatus 12 optionally includes a proximity or precrash sensor 40. The precrash sensor 40 is a device that senses the distance of an object from the vehicle 10 and that determines if an impact event between the vehicle and the object is impending. If an impact event is impending, the precrash sensor 40 provides a precrash signal indicative of the impending condition. The precrash sensor 40 may use radar, vision, or other techniques to sense the proximity of the object to the vehicle 10.

A controller 44 is operatively connected to the front and side crash sensors 32 and 36 and receives the front and side crash signals from the front and side crash sensors, respectively. When the apparatus 12 includes the precrash sensor 40, the controller 44 is also operatively connected to the precrash sensor 40 and receives the precrash signal. Other sensor inputs may similarly be present in the apparatus 12, such as, for example, a seat belt use input. An exemplary system having other sensor inputs is disclosed in U.S. Pat. No. 5,626,359. The controller 44 is preferably a microcomputer. The controller 44, in response to receiving one or more of the front crash signal, the side crash signal, and the precrash signal, compares the received crash signals to associated thresholds to determine whether a deployment crash event is taking place or is impending. The controller 44 compares the front crash signal to a predetermined front crash threshold and, when the front crash signal exceeds the threshold, determines that a front impact deployment crash event is occurring. Likewise, the controller 44 compares the side crash signal to a predetermined side crash threshold and, when the side crash signal exceeds the threshold, determines that a side impact deployment crash event is occurring.

The apparatus 12 also includes a front air bag module 46 that is mounted to the vehicle 10 in a location within the instrument panel 28. As is shown schematically in FIG. 2, the front air bag module 46 includes an inflator 48 and a front air bag 50. The inflator 48 and the front air bag 50, when in a deflated and stored condition, are located in a housing 52 (FIG. 1) of the front air bag module 46. The inflator 48 of the front air bag module 46 is operatively connected to the controller 44 and is actuatable by the controller for providing inflation fluid to the front air bag 50. The front air bag 50, upon receiving inflation fluid from the inflator 48, inflates from the deflated and stored condition to an inflated condition. Dashed lines in FIG. 1 show the front air bag 50 in the inflated condition. In the inflated condition, the front air bag 50 is located forward of the seat 14 and is interposed between the seat and the instrument panel 28.

The front air bag module 46 is configured to sustain the front air bag 50 in an inflated condition for an extended period of time, such as a period of time of at least about 300 milliseconds. The sustained inflated condition of the front air bag 50 helps to provide enhanced protection for the occupant 30 of the vehicle 10 during the occurrence of subsequent impacts of certain multiple impact crash events and helps to maintain the occupant in the seat 14 during the occurrence of both single and multiple direction impact crash events.

In a first exemplary embodiment of the front air bag module 46, the inflator 48 includes a slow, long burning gas generant material. When the inflator 48 of the first exemplary embodiment is actuated, the slow, long burning gas generant material provides a sufficient amount of inflation fluid to inflate the front air bag 50 completely, in a timely manner, into the inflated condition. The slow, long burning gas generant material continues to provide inflation fluid to the front air bag 50 over a period of time sufficient for sustaining the front air bag in the inflated condition for the extended period of time.

In another exemplary embodiment of the front air bag module 46, the front air bag 50 is coated with material to help seal the front air bag against air leakage, i.e., making the front air bag less porous. The coated front air bag 50 holds inflation fluid received from the inflator 48 for a sufficient period of time to sustain the front air bag in the inflated condition for an extended period of time.

In yet another exemplary embodiment of the front air bag module 46, the inflator 48 is a two-stage inflator. A cross-section of an exemplary two-stage inflator 48′ is illustrated in FIG. 3. The two-stage inflator 48′ of FIG. 3 includes a housing 60 defining first and second chambers 62 and 64, respectively, and a diffuser 66. A first opening 68 connects the first chamber 62 and the diffuser 66. Similarly, a second opening 70 connects the second chamber 64 and the diffuser 66. Rupturable burst disks 72 and 74 close the first and second openings 68 and 70, respectively. The diffuser 66 includes a plurality of gas exit ports. 76 for enabling the flow of inflation fluid out of the two-stage inflator 48′.

A first quantity of gas generant material 78 is located in the first chamber 62. A first squib 80 is associated with the first chamber 62 and, in response to an actuation signal from the controller 44, ignites the first quantity of gas generant material 78. The first quantity of gas generant material 78 and the first squib 80 collectively define a primary stage of the two-stage inflator 48′. When the first quantity of gas generant material 78 is ignited, inflation fluid produced from the ignited first quantity of gas generant material ruptures the burst disk 72 covering the first opening 68 and flows into the diffuser 66. The inflation fluid then flows out of the diffuser 66 through the gas exit ports 76 and into the front air bag 50. The rupturable burst disk 74 that closes the second opening 70 prevents actuation of the primary stage of the two-step inflator 48′ from causing the actuation of a secondary stage.

A second quantity of gas generant material 82 is located in the second chamber 64. A second squib 84 is associated with the second chamber 64 and, in response to an actuation signal from the controller 44, ignites the second quantity of gas generant material 82. The second quantity of gas generant material 82 and the second squib 84 collectively define the secondary stage of the two-stage inflator 48′. When the second quantity of gas generant material 82 is ignited, inflation fluid produced from the ignited second quantity of gas generant material 82 ruptures the burst disk 74 covering the second opening 70 and flows into the diffuser 66. The inflation fluid then flows out of the diffuser 66 through the gas exit ports 76 and into the front air bag 50.

The two-stage inflator 48′ of FIG. 3 may enable both normal inflation of the front air bag 50 and sustained inflation of the front air bag. During normal inflation, which generally occurs during the occurrence of a single impact, frontal crash event, the two-stage inflator 48′ operates in a known manner for inflating the front air bag. During normal inflation, for full inflation of the front air bag 50, the secondary stage is actuated either at the same time as or after a short delay from actuation of the primary stage. During sustained inflation, in which the front air bag 50 is sustained in the inflated condition for the extended period of time, the duration of a delay between actuation of the primary stage and actuation of the secondary stage is increased relative to the delay during normal inflation. For example, the delay between actuation of the primary stage and actuation of the secondary stage of the two-stage inflator 48′ may be 100 milliseconds. The increased delay results in the front air bag 50 being sustained in the inflated condition for the extended period of time.

In addition to, or as an alternative to, controlling sustained inflation of the front air bag 50 with a delay in actuation of the secondary stage of the two-stage inflator 48′, the second quantity of gas generant material 82 of the secondary stage may include a slow, long burning gas generant material. The slow, long burning gas generant material maintains a flow of inflation fluid into the front air bag 50 so as to sustain inflation for the extended period of time.

The inflators discussed above are for exemplary purposes only. The apparatus 12 of the present invention is not limited by the type of inflator used to inflate the front air bag 50. It should be understood that other types of inflators, for example, stored gas inflators, hybrid inflators, and augmented inflators, may be used to inflate the front air bag 50.

The apparatus 12 also includes a side air bag module 90 that is located within the backrest portion 18 of the seat 14 of the vehicle 10. As is shown schematically in FIG. 2, the side air bag module 90 includes an inflator 92 and a side air bag 94. The inflator 92 and the side air bag 94, when in a deflated and stored condition, are located in a housing 96 (FIG. 1) of the side air bag module 90. The inflator 92 of the side air bag module 90 is operatively connected to the controller 44 and is actuatable by the controller for providing inflation fluid to the side air bag 94. The side air bag 94, upon receiving inflation fluid from the inflator 92, inflates from the deflated and stored condition to an inflated condition. Dashed lines in FIG. 1 show the side air bag 94 in the inflated condition. In the inflated condition, the side air bag 94 is located beside the seat 14 and is interposed between an occupant 30 of the seat 14 and the side structure of the vehicle 10, such as side window 98 (FIG. 1).

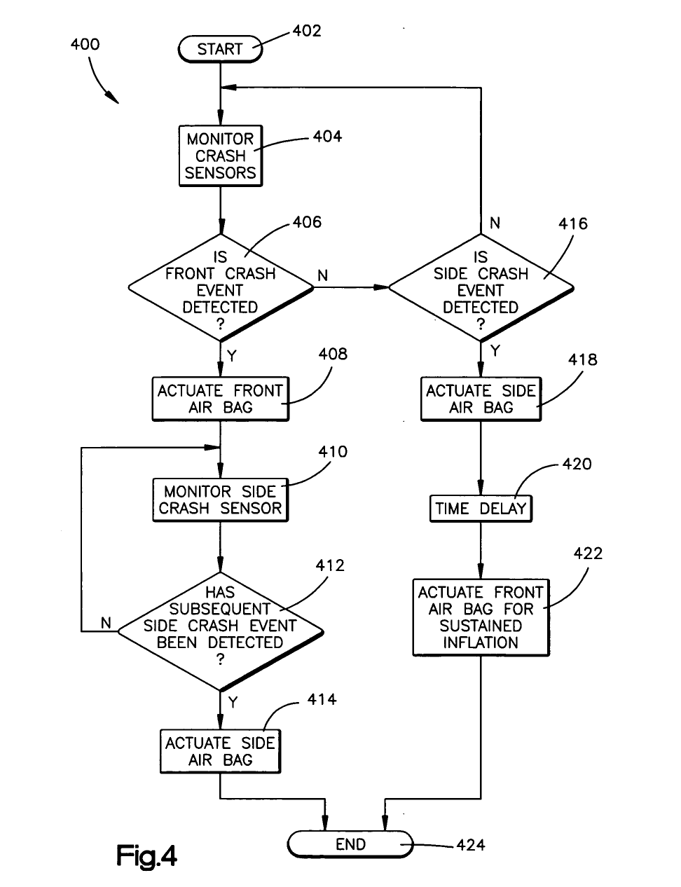

FIG. 4 is a flow diagram illustrating a process 400 performed by an apparatus 12 constructed in accordance with the present invention. The process 400 begins at step 402. In a preferred embodiment, the process 400 begins when an ignition switch (not shown) of the vehicle 10 is closed. At step 404, the controller 44 checks the front and side crash sensors 32 and 36. At step 406, the controller 44 determines whether a front impact deployment crash event has been detected. When the controller 44 determines that a received front crash signal exceeds the front crash threshold, the determination at step 406 is affirmative and the process 400 proceeds to step 408.

At step 408, the controller 44 actuates the front air bag module 46 to begin inflation of the front air bag 50. To actuate the front air bag module 46, the controller 44 sends an actuation signal to the inflator 48 of the front air bag module 46. Upon receiving the actuation signal, the inflator 48 is actuated to provide inflation fluid to the front air bag 50.

From step 408, the process 400 proceeds to step 410. At step 410, the controller 44 again checks the side crash sensor 36. At step 412, the controller 44 determines whether a side impact deployment crash event has been detected. When the controller 44 determines that a received side crash signal exceeds the side crash threshold, the determination at step 412 is affirmative and the process 400 proceeds to step 414. When the determination at step 412 is negative, the process 400 returns to step 410.

At step 414, the controller 44 actuates the side air bag module 90 to begin inflation of the side air bag 94. To actuate the side air bag module 90, the controller 44 sends an actuation signal to the inflator 92 of the side air bag module 90. Upon receiving the actuation signal, the inflator 92 of the side air bag module 90 is actuated to provide inflation fluid to the side air bag 94, causing the side air bag to inflate. From step 414, the process 400 proceeds to step 424 and the process ends.

When the determination at step 406 is negative, the process 400 proceeds to step 416. At step 416, the controller 44 determines whether a side impact deployment crash event has been detected. When the controller 44 determines that a received side crash signal exceeds the side crash threshold, the determination at step 416 is affirmative and the process 400 proceeds to step 418. When the determination at step 416 is negative, the process 400 returns to step 404.

At step 418, the controller 44 actuates the side air bag module 90 to begin inflation of the side air bag 94. To actuate the side air bag module 90, the controller 44 sends an actuation signal to the inflator 92 of the side air bag module 90. Upon receiving the actuation signal, the inflator 92 of the side air bag module 90 is actuated to provide inflation fluid to the side air bag 94 and the side air bag is inflated.

From step 418, the process 400 proceeds to step 420 in which a time delay occurs. In a preferred embodiment, the time delay at step 420 is approximately 100 milliseconds. The process 400 then proceeds to step 422 in which the controller 44 actuates the front air bag module 46 to begin inflation of the front air bag 50. To actuate the front air bag module 46, the controller 44 sends an actuation signal to the inflator 48 of the front air bag module 46. Upon receiving the actuation signal, the inflator 48 of the front air bag module 46 is actuated to provide inflation fluid to the front air bag 50. The front air bag 50 is sustained in the inflated condition for the extended period of time. Thus, when the delay at step 420 is 100 milliseconds and the extended period of time for sustained inflation of the front air bag 50 is at least about 300 milliseconds, the front air bag 50 remains in the inflated condition until at least 400 milliseconds after the actuation of the side air bag module 90. From step 422, the process 400 proceeds to step 424 and the process ends.

When the apparatus 12 includes the optional precrash sensor 40, the front air bag 50 may be inflated in response to the precrash signal. In a multiple impact crash event, the side air bag 94 inflates after the front air bag 50 and in response the side crash sensor 36 indicating a subsequent side impact event of the vehicle 10.

The table 1 summarizes the process 400 described with reference to FIG. 4:

TABLE 1

| | | Front Air Bag | |
|---|---|---|---|
| Vehicle | Normal Front | with | |
| Impact | Air Bag | Sustained | |
| Event | Inflation | Inflation | Side Air Bag |
| Front Only | Actuated | | Not Actuated |
| | Immediately | | |
| | after Receipt | | |
| | of Front | | |
| | Crash Signal | | |
| Side Only | | Actuated on a | Actuated |
| | | Delay After | Immediately |
| | | Side Air Bag | after |
| | | | Receipt of |
| | | | Side Crash |
| | | | Signal |
| Front | | Actuated | Actuated |
| followed | | Immediately | Immediately |
| by Side | | after Receipt | after |
| | | of Front | Receipt of |
| | | Crash Signal | Side Crash |
| | | | Signal |

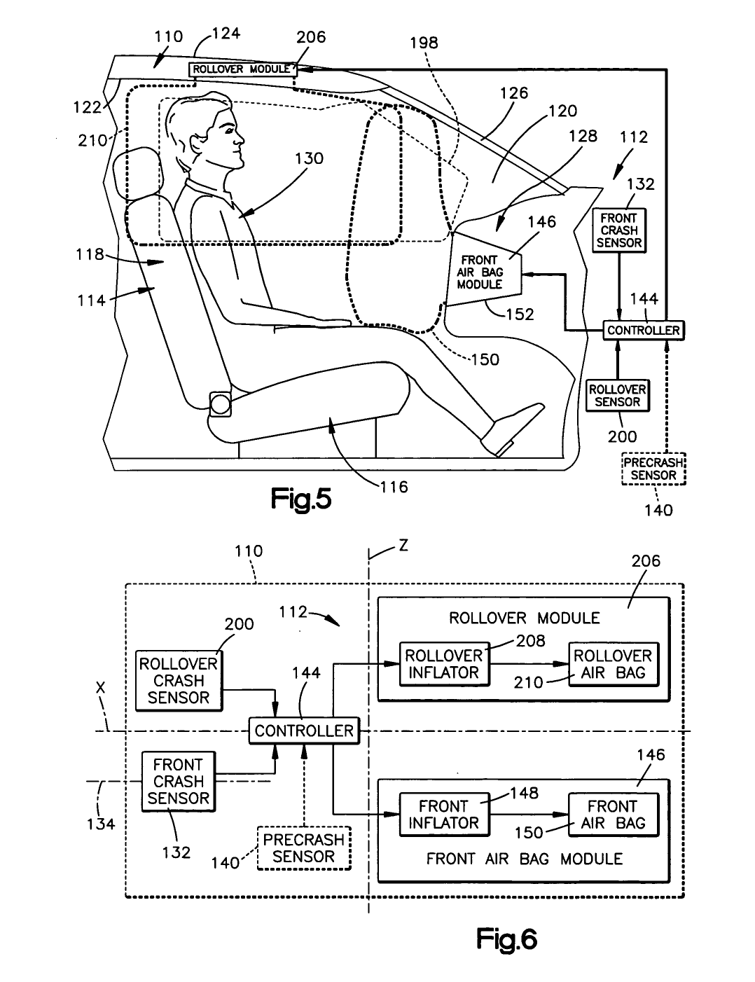

FIG. 5 is a schematic side view of a vehicle 110 including an apparatus 112 constructed in accordance with a second embodiment of present invention. Structures of FIG. 5 that are the same or similar to structures of FIG. 1 are numbered with the same reference number plus 100.

For exemplary purposes, the apparatus 112 illustrated in FIG. 5 is associated with a front passenger seat 114 in the passenger compartment 120 of the vehicle 110. The apparatus 112 may be associated with other seats (not shown) of the vehicle 110. The structure of the vehicle 110 of FIG. 5 includes a headliner 122, a roof 124, a windshield 126, an instrument panel 128, and a side window 198. The passenger seat 114 includes a cushion portion 116 and a backrest portion 118.

The apparatus 112 includes a front crash sensor 132 for sensing a front impact event of the vehicle 110 and for providing a front crash signal in response to the sensed front impact event. The front crash sensor 132 may include an accelerometer having an axis of sensitivity 134 that extends parallel to a longitudinal axis X of the vehicle 110. The longitudinal axis X and the vertical axis Z of the vehicle 110 are shown schematically in FIG. 6. Alternatively, the front crash sensor 132 may include a crush sensor for sensing deformation or crush of a front portion of the vehicle 110.

A rollover sensor 200 of the apparatus 112 senses a rollover event of the vehicle 110 and provides a rollover signal in response to the sensed rollover event. The rollover sensor 200 may include a device for sensing a roll rate about the longitudinal axis X of the vehicle 110. Alternative types of rollover sensors may also be used for determining a rollover event of the vehicle 110.

The apparatus 112 optionally includes a proximity or precrash sensor 140. The precrash sensor 140 is a device that senses the distance of an object from the vehicle 110 and that determines if an impact event between the vehicle and the object is impending. If an impact event is impending, the precrash sensor 140 provides a signal indicative of the impending condition. The precrash sensor 140 may use radar to sense the proximity of the object to the vehicle 110.

A controller 144 is operatively connected to the front crash sensor 132 and the rollover sensor 200 and receives the front crash signal and the rollover signal. When the apparatus 112 includes the optional precrash sensor 140, the controller 144 is also operatively connected to the precrash sensor 140 and receives the precrash signal. The controller 144 is preferably a microcomputer. The controller 144, in response to receiving one or more of the front crash signals, the rollover signal, and the precrash signal compares the received signals to associated crash thresholds to determine whether a deployment crash event is taking place or is impending.

The apparatus 112 also includes a front air bag module 146 that is located within the instrument panel 128 of the vehicle 110. As is shown schematically in FIG. 6, the front air bag module 146 includes an inflator 148 and a front air bag 150. The inflator 148 and the front air bag 150, when in a deflated and stored condition, are located in a housing 152 (FIG. 5) of the front air bag module 146. The inflator 148 is operatively connected to the controller 144 and is actuatable by the controller for providing inflation fluid to the front air bag 150. The front air bag 150, upon receiving inflation fluid from the inflator 148, inflates from the deflated and stored condition to an inflated condition. Dashed lines in FIG. 5 show the front air bag 150 in the inflated condition. In the inflated condition, the front air bag 150 is located forward of the seat 114 and is interposed between the seat and the instrument panel 128.

The front air bag module 146 is configured to sustain the front air bag 150 in the inflated condition for an extended period of time, such as a period of time of at least about 300 milliseconds. The sustained inflation of the front air bag 150 provides enhanced protection for the occupant 130 of the vehicle 110 during the occurrence of subsequent impacts of a multiple impact crash event and helps to maintain the occupant in the seat 114 during the occurrence of both single and multiple impact crash events.

The apparatus 112 of FIG. 5 also includes a rollover module 206 that is located between the headliner 122 and the roof 124 of the vehicle 110. As is shown schematically in FIG. 6, the rollover module 206 includes an inflator 208 and a rollover air bag 210. The inflator 208 is operatively connected to the controller 144 and is actuatable by the controller for providing inflation fluid to the rollover air bag 210. The rollover air bag 210, upon receiving inflation fluid from the inflator 208, inflates from the deflated and stored condition to an inflated condition. Dashed lines in FIG. 5 show the rollover air bag 210 in the inflated condition. In the inflated condition, the rollover air bag 210 is located beside the seat 114 and is interposed between an occupant 130 of the seat and the side structure of the vehicle, such as the side window 198.

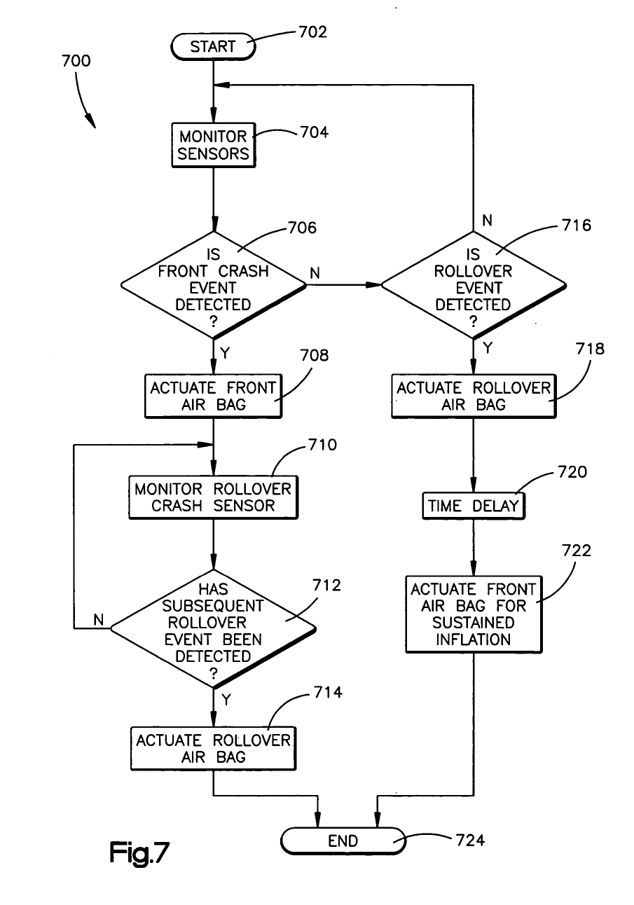

FIG. 7 is a flow diagram illustrating a process 700 performed by an apparatus 112 constructed in accordance with the second embodiment of the present invention. The process 700 begins at step 702. In a preferred embodiment, the process 700 begins when an ignition switch (not shown) of the vehicle 110 is closed. At step 704, the controller 144 checks the front crash sensor 132 and the rollover sensor 200. At step 706, the controller 144 determines whether a front impact deployment crash event has been detected. When the controller 144 determines that a received front crash signal exceeds the front crash threshold, the determination at step 706 is affirmative and the process 700 proceeds to step 708.

At step 708, the controller 144 actuates the front air bag module 146 to begin inflation of the front air bag 150. To actuate the front air bag module 146, the controller 144 sends an actuation signal to the inflator 148 of the front air bag module 146. Upon receiving the actuation signal, the inflator 148 of the front air bag module 146 is actuated to provide inflation fluid to the front air bag 150. The front air bag 150 is inflated.

From step 708, the process 700 proceeds to step 710. At step 710, the controller 144 again checks the rollover sensor 200. At step 712, the controller 144 determines whether a rollover deployment event has been detected. When the controller 144 determines that a received rollover signal exceeds the rollover threshold, the determination at step 712 is affirmative and the process 700 proceeds to step 714. When the determination at step 712 is negative, the process 700 returns to step 710.

At step 714, the controller 144 actuates the rollover module 206 to begin inflation of the rollover air bag 210. To actuate the rollover module 206, the controller 144 sends an actuation signal to the inflator 208 of the rollover module 206. Upon receiving the actuation signal, the inflator 208 of the rollover module 206 is actuated to provide inflation fluid to the rollover air bag 210 and the rollover air bag is inflated. From step 714, the process 700 proceeds to step 724 and the process ends.

When the determination at step 706 is negative, the process 700 proceeds to step 716. At step 716, the controller 144 determines whether a rollover deployment event has been detected. When the controller 144 determines that a received rollover signal exceeds the rollover threshold, the determination at step 716 is affirmative and the process 700 proceeds to step 718. When the determination at step 716 is negative, the process 700 returns to step 704.

At step 718, the controller 144 actuates the rollover module 206 to begin inflation of the rollover air bag 210. To actuate the rollover module 206, the controller 144 sends an actuation signal to the inflator 208 of the rollover module 206. The rollover module 206 may includes a plurality of inflators, such as two separate inflators, for inflating the rollover air bag 218. Upon receiving the actuation signal, the inflator 208 of the rollover module 206 is actuated to provide inflation fluid to the rollover air bag 210 and the rollover air bag is inflated.

From step 718, the process 700 proceeds to step 720 in which a time delay occurs. In a preferred embodiment, the time delay at step 720 is approximately 100 milliseconds. The process 700 then proceeds to step 722 in which the controller 144 actuates the front air bag module 146 to begin inflation of the front air bag 150. To actuate the front air bag module 146, the controller 144 sends an actuation signal to the inflator 148 of the front air bag module 146. Upon receiving the actuation signal, the inflator 148 of the front air bag module 146 is actuated to provide inflation fluid to the front air bag 150. The front air bag 150 is inflated and is sustained in the inflated condition for the extended period of time. Thus, when the delay at step 720 is 100 milliseconds and the extended period of time for sustained inflation of the front air bag 150 is 300 milliseconds, the front air bag 150 remains in the sustained inflated condition until at least 400 milliseconds after the actuation of the rollover module 206. From step 722, the process 700 proceeds to step 724 and the process ends.

When the apparatus 112 includes the optional precrash sensor 140, the front air bag 150 may be inflated in response to the precrash signal. In a multiple impact crash event, the rollover air bag 210 inflates after the front air bag 150 and in response the rollover crash sensor 200 indicating a subsequent rollover of the vehicle 110.

The table 2 summarizes the process 700 described with reference to FIG. 7.

TABLE 2

| Vehicle | Normal Front | Front Air Bag | |
|---|---|---|---|
| Impact | Air Bag | with Sustained | Rollover |
| Event | Inflation | Inflation | air bag |
| Front Only | Actuated | | Not |
| | Immediately | | Actuated |
| | after Receipt | | |
| | of Front Crash | | |
| | Signal | | |
| Rollover | | Actuated on a | Actuated |
| Only | | Delay After | Immediately |
| | | Rollover Air | after |
| | | Bag | Receipt of |
| | | | Rollover |
| | | | Signal |
| Front | | Actuated | Actuated |
| followed by | | Immediately | Immediately |
| Rollover | | after Receipt | after |
| | | of Front Crash | Receipt of |
| | | Signal | Rollover |
| | | | Signal |

From the above description of the invention, those skilled in the art will perceive improvements, changes and modifications. Such improvements, changes and modifications within the skill of the art are intended to be covered by the appended claims.

1. An apparatus for helping to protect an occupant of a seat of a vehicle, the apparatus comprising:
a sensor responsive to at least one of a side impact event or a rollover event for providing a crash event signal;
a first vehicle occupant protection device that is inflatable into a first position located beside the seat;
a second vehicle occupant protection device that is inflatable into a second position located forward of the seat; and
a controller responsive to the crash event signal for immediately inflating the first vehicle occupant protection device and, a predetermined time after inflation of the first vehicle occupant protection device, inflating the second vehicle occupant protection device.

2. The apparatus of claim 1 wherein the first vehicle occupant protection device is a side air bag.

3. The apparatus of claim 1 wherein the first vehicle occupant protection device is a rollover air bag.

4. The apparatus of claim 1 wherein the second vehicle occupant protection device is configured to remain in a mostly inflated condition in the second position for an extended period of time.

5. The apparatus of claim 4 wherein the extended period of time is at least about 300 milliseconds.

6. The apparatus of claim 4 further including an inflator associated with the second vehicle occupant protection device, the inflator being adapted to provide inflation fluid to the second vehicle occupant protection device so as to sustain the second vehicle occupant protection device in the inflated condition for the extended period of time.

7. The apparatus of claim 6 wherein the inflator includes first and second actuatable stages, the controller actuating the first actuatable stage to inflate the second vehicle occupant protection device into the inflated condition and actuating the second actuatable stage so as to sustain the second vehicle occupant protection device in the inflated condition for the extended period of time.

8. The apparatus of claim 4 wherein the second vehicle occupant protection device is a front air bag that is of a sealed design so as to help prevent inflation fluid loss from the front air bag, the front air bag remaining in the inflated condition for the extended period of time.

9. The apparatus of claim 1 further including a precrash sensor for sensing an impending impact event and providing a precrash signal, the controller, in response to initially receiving the precrash signal, inflating the second vehicle occupant protection device, the controller being responsive to a subsequently received crash event signal for inflating the first vehicle occupant protection device.

10. An apparatus for helping to protect an occupant of a seat of a vehicle, the apparatus comprising:
a sensor responsive to at least one of a side impact event or a rollover event for providing a crash event signal;
a first vehicle occupant protection device that is inflatable into a first position located beside the seat;
a second vehicle occupant protection device that is inflatable into a second position located forward of the seat; and
a controller responsive to the crash event signal from the sensor for inflating both the first and second vehicle occupant protection devices.

11. The apparatus of claim 10 further including a sensor that is responsive to a front impact event for providing a front crash signal, the controller, in response to initially receiving the front crash signal, inflating the second vehicle occupant protection device, the controller being responsive to a subsequently received crash event signal for inflating the first vehicle occupant protection device.

12. The apparatus of claim 10 further including a precrash sensor for sensing an impending impact event and providing a precrash signal, the controller, in response to initially receiving the precrash signal, inflating the second vehicle occupant protection device, the controller being responsive to a subsequently received crash event signal for inflating the first vehicle occupant protection device.

13. The apparatus of claim 10 wherein the second vehicle occupant protection device is configured to remain in a mostly inflated condition in the second position for an extended period of time.

14. The apparatus of claim 13 wherein the extended period of time is at least about 300 milliseconds.

15. The apparatus of claim 13 further including an inflator associated with the second vehicle occupant protection device, the inflator being adapted to provide inflation fluid to the second vehicle occupant protection device so as to sustain the second vehicle occupant protection device in the inflated condition for the extended period of time.

16. The apparatus of claim 13 wherein the inflator includes first and second actuatable stages, the controller actuating the first actuatable stage to inflate the second vehicle occupant protection device into the inflated condition and actuating the second actuatable stage so as to sustain the second vehicle occupant protection device in the inflated condition for the extended period of time.

17. The apparatus of claim 13 wherein the second vehicle occupant protection device is a front air bag that is of a sealed design so as to help prevent inflation fluid loss from the front air bag, the front air bag remaining in the inflated condition for the extended period of time.

18. The apparatus of claim 10 wherein the controller, in response to receiving the crash event signal, inflates the first vehicle occupant protection device and, a short time after inflating the first vehicle occupant protection device, inflates the second vehicle occupant protection device.

19. An apparatus for helping to protect an occupant of a seat of a vehicle, the apparatus comprising:
a sensor for sensing a vehicle crash condition and for providing a crash event signal;
a first vehicle occupant protection device that is mounted to the vehicle in a position forward of the seat and is inflatable into a first position located forward of the seat; and
a controller responsive to the crash event signal for inflating the first vehicle occupant protection device,
the first vehicle occupant protection device being configured to remain in a mostly inflated condition in the first position for at least about 300 milliseconds.

20. The apparatus of claim 19 further including a second vehicle occupant protection device that is inflatable into a second position located beside the seat, the controller also being responsive to the crash event signal for inflating the second vehicle occupant protection device.

21. The apparatus of claim 19 wherein the sensor is adapted to provide the crash event signal in response to at least one of a side impact event or a rollover event.

22. The apparatus of claim 21 wherein the controller, in response to receiving the crash event signal, immediately inflates the second vehicle occupant protection device and, a predetermined time after inflation of the second vehicle occupant protection device, inflates the first vehicle occupant protection device.

23. The apparatus of claim 20 wherein the sensor is a precrash sensor adapted to sense an impending impact event and for providing the crash event signal in response to sensing the impending impact event.

24. A method for helping to protect an occupant of a seat of a vehicle, the method comprising the steps of:
sensing at least one of a side impact event or a rollover event and providing a crash event signal;
immediately inflating a first vehicle occupant protection device into a first position located beside the seat; and
inflating, a predetermined time after inflating the first vehicle occupant protection device, a second vehicle occupant protection device into a second position located forward of the seat.

25. The method of claim 24 further including the step of sustaining the second vehicle occupant protection device in a mostly inflated condition in the second position for an extended period of time.

26. The method of claim 25 wherein the step of sustaining the second vehicle occupant protection device in a mostly inflated condition in the second position for an extended period of time further includes the step of sustaining the second vehicle occupant protection device in the mostly inflated condition for at least about 300 milliseconds.

27. The method of claim 24 further including the steps of:
sensing an impending impact event and providing a precrash signal;
inflating the second vehicle occupant protection device in response to initially receiving the precrash signal; and
inflating the first vehicle occupant protection device in response to a subsequently received crash event signal.

28. A method for helping to protect an occupant of a seat of a vehicle, the method comprising the steps of:
sensing at least one of a side impact event or a rollover event for providing a crash event signal;
inflating a first vehicle occupant protection device into a first position located beside the seat; and
inflating a second vehicle occupant protection device into a second position located forward of the seat.

29. The method of claim 28 further including the steps of:
sensing a front impact event and providing a front crash signal;
inflating the second vehicle occupant protection device in response to initially receiving the front crash signal; and
inflating the first vehicle occupant protection device in response to a subsequently received crash event signal.

30. The method of claim 28 further including the steps of:
sensing an impending impact event and providing a precrash signal;
inflating the second vehicle occupant protection device in response to initially receiving the precrash signal; and
inflating the first vehicle occupant protection device in response to a subsequently received crash event signal.

31. The method of claim 28 further including the step of sustaining the second vehicle occupant protection device in a mostly inflated condition in the second position for an extended period of time.

32. The method of claim 31 wherein the step of sustaining the second vehicle occupant protection device in a mostly inflated condition in the second position for an extended period of time further includes the step of sustaining the second vehicle occupant protection device in the mostly inflated condition for at least about 300 milliseconds.

33. A method for helping to protect an occupant of a seat of a vehicle, the method comprising the steps of:
sensing a vehicle crash condition and providing a crash event signal;
inflating a first vehicle occupant protection device into a first position located forward of the seat; and
sustaining the first vehicle occupant protection device in a mostly inflated condition in the first position for at least about 300 milliseconds.

34. The method of claim 33 further including the step of inflating a second vehicle occupant protection device into a second position located beside the seat.

35. The method of claim 33 wherein the step of sensing a vehicle crash condition and providing a crash event signal further includes the step of sensing at least one of a side impact event or a rollover event.

36. The method of claim 35 further including the step of delaying a predetermined time after inflation of the second vehicle occupant protection device prior to inflating the first vehicle occupant protection device.
